(19) United States
(12) Patent Application Publication
(10) Pub. No.: US 2014/0066558 A1
(43) Pub. Date: Mar. 6, 2014

(54) ANTISTATIC FOAM AGENT AND ANTISTATIC MASTER BATCH FOR PRODUCING FOAMED PLASTIC ITEMS

(71) Applicant: Jürgen Keilert, Wintzenheim (FR)

(72) Inventor: Jürgen Keilert, Wintzenheim (FR)

(21) Appl. No.: 14/013,233

(22) Filed: Aug. 29, 2013

(30) Foreign Application Priority Data
Aug. 31, 2012 (DE) 102012108134.4

(51) Int. Cl. C08K 13/02; C08J 3/22

(52) U.S. Cl. CPC C08K 13/02; C08J 3/226
USPC 524/315; 106/316; 524/582

(57) ABSTRACT

A foaming agent or a master batch comprising a foaming agent for producing hollow-shaped foamed plastics using a blow-molding process containing an antistatic agent. The antistatic agent can comprise a fatty acid ester, an ethoxylated amine, or an alkyl sulfonate. In addition, the invention comprises a method for producing hollow-shaped, foamed plastics using the antistatic agent/master batch. The use of the antistatic agent results in a reproducible, stable production of hollow foamed plastic products such as bottles or yogurt cups with a better cellular structure, which produces a soft, rough surface of the products with a better feel.

### CROSS REFERENCE TO RELATED APPLICATIONS

This application is a Continuation and claims priority to and the benefit of co-pending DE Application No. 10 2012 108 134.4, which was filed on Aug. 31, 2012. This reference is incorporated in their entirety herein.

### FIELD

The present embodiments generally relate to an antistatic foaming agent, an antistatic master batch, and a method for producing foamed plastic items.

### BACKGROUND

As compared to non-foamed plastic items, foamed plastic items offer the advantage that less plastic has to be used as the starting material, and the finished item consequently has a lighter weight but is nevertheless sturdy and can withstand mechanical loads. The properties of the plastic items, such as their color or UV stability, can be changed and improved by adding master batches, which is to say granular mixtures of plastic additives, to a raw polymer.

Until now, however, it has not proven to be especially suitable to use a master batch in the production of foamed plastics, since the customary variation in the dosing and local dosing of a master batch results in substantial problems in the production process, and even in production downtimes. While certain variations in the dosing for non-foamed plastics are accepted for many applications, such as dye dosages, because they do not adversely affect the manufacturing process, a precision of 0.1 percent of the expanding foaming agent contained or of the master batch comprising foaming agent is required for the manufacture of foamed plastic items such as hollow articles (bottles, yogurt cups), for example using the blow-molding process. This means, for example, that for a 10 g blow-molded article (bottle) with an input of 0.7 percent of the foaming agent, which corresponds to an input mass of 70 mg foaming agent per blow-molded article, that just a single 10 mg granule leads to production problems. In this regard, reproducible and stable production of the blow-molded articles using a foaming agent and/in a master batch is not possible using the prior art.

Consequently, an object of the present invention is to provide a method or a product that ensures reproducible and stable production of foamed plastic items, in particular hollow items such as blow-molded articles (bottles, yogurt cups), using master batches such that the end products can be produced to be dimensionally stable and can be given new properties defined by the master batch.

### BRIEF DESCRIPTION OF THE DRAWINGS

N/A

### DETAILED DESCRIPTION OF THE EMBODIMENTS

Before explaining the present process in detail, it is to be understood that the process is not limited to the particular embodiments and that it can be practiced or carried out in various ways.

The present embodiments generally relate to an antistatic foaming agent, an antistatic master batch, and a method for producing foamed plastic items.

According to the embodiments, an object is attained by a: foaming agent for producing foamed plastic items, in particular hollow articles using a blow-molding process, comprising an antistatic agent.

A foaming agent comprising an antistatic agent includes the advantage that the master batch and the foaming agent do not adhere to the walls of conveying units, storage containers, feeding devices, metering mechanisms, inlets and outlets, etc. of processing machines, such as injection molding machines, extrusion units, or blow-molding units, etc., so that errors in the metered addition to the plastic or to the processing machine are reduced. This prevents underfeeding in that a smaller quantity of the master batch adheres to the walls, and also prevents overfeeding in the case when the adhering master batch is released from the walls by mechanical influences or simply gravity. As a result of the use of a foaming agent comprising an antistatic agent, it is possible to ensure a precision of 0.1 percent or better in metering of the master batch so that the foamed plastic products can be produced in a reproducible and dimensionally stable way.

In embodiments, the antistatic agent comprises: a fatty acid ester, such as a glycerol monostearate or a glycerol stearate. As an antistatic agent, fatty acid esters are suitable for producing polyethylene or polypropylene-based plastics. Not only does the use of a glycerol monostearate reliably prevent static charging of the master batch, however, but it also results in an improvement in the cellular structure in the end product, which leads to a better feel because of the soft, rough surface.

In another embodiment, the antistatic agent of the foaming agent can comprise ethoxylated amines and/or alkyl sulfonates. While ethoxylated amines can be used by for processing polyolefins, such as polyethylene and polypropylene, processing styrenes, such as polystyrene, styrene acrylonitrile, acrylonitrile-butadiene-styrene copolymers, and high impact polystyrene, and for processing polyvinyl chloride, alkyl sulfonates can be used for processing styrenes, such as polystyrene, styrene acrylonitrile, acrylonitrile-butadiene-styrene copolymers, and high impact polystyrene, and for processing polyvinyl chloride.

For styrene-based foaming agent batches, such as polystyrene, an alkyl sulfonate or an ethoxylated amine can be used.

The ethoxylated amine can have the following formula:

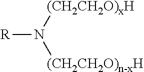

where R represents an alkyl radical with from 10 carbon atoms to 18 carbon atoms and n represents the total number of moles of ethylene oxide, where n corresponds to 2 moles to 15 moles. This embodiment has the advantage that the input quantities of the antistatic agent can be kept small even for processing of polyvinyl chloride and styrenes, so that no permanent antistatic behavior is produced in the end product, but rather that adhesion of the master batch, particularly to the walls of the metering mechanisms, in the piping, and particularly during mixing of the master batch with the polymer, is prevented.

In addition to the antistatic agent, the foaming agent includes at least one of the following constituents: sodium hydrogen carbonate, a carboxylic acid, for example citric acid and its derivatives, and a solid acting as a nucleation agent. This mixture generates CO2 as a blowing agent, which is CFC-free, and hence does not contribute to the greenhouse effect, is relatively easy to dispose of because of its lack of chlorine, and is environmentally friendly within the limits of the quantity released.

Furthermore, as compared to exothermic foaming agents such as azodicarbonamide or hydrazines, it has the advantage of lower flammability, which makes the mixture a safe foaming agent. Moreover, it is relatively economical.

In embodiments, the particle size of the individual constituents of the foaming agent is preferably ≦40 μm, more preferably ≦30 μm, and especially preferably ≦15 μm.

In general, all solid nucleation agents can be used as the nucleation agent; preferably talc, chalk, metal oxides, silicon dioxide, or color pigments, or combinations thereof, but also fiber-like fillers such as, e.g., short glass fibers, act as physical nucleation agents.

In embodiments, the constituents of the foaming agent are used in a weight ratio of sodium hydrogen carbonate to monosodium citrate to nucleation agent of 1 to 0.5-5 to 3-13.5 percent by weight, preferably in a weight ratio of 1 to 0.5-2.5 to 3-6 percent by weight, especially preferably in a ratio of 1 to 0.5-2 to 3-4 percent by weight.

A foaming agent of this nature generates approximately 12 ml to 35 ml gas per gram of foaming agent, which brings about relatively low mechanical loads so that the resultant gas bubbles can be distributed uniformly, which improves the quality of the foaming process, and in turn increases the stability and mechanical strength of the plastic product.

In all the embodiments mentioned, the foaming agent can be used as a component of a master batch or individually.

Consequently, therefore, another part of the present invention is a master batch that comprises: a foaming agent, which in turn comprises an antistatic agent with the properties described above. Advantages are the simultaneous foaming of the plastic and the addition of other properties, as well as the long life and the failure to adhere to walls of the processing equipment. For example, the master batch can contain additional additives that produce coloration, flame-retardancy, UV stabilization, sterility, or other properties. Additives that can be considered are customary substances in the manufacture and processing of plastics that are known to those skilled in the art and described in the literature, for example lubricants or mold release agents, heat stabilizers (antioxidants), softeners, light stabilizers (UV stabilizers), flame retardants, and other additives, or mixtures thereof.

The foaming agent and the master batch can be used to produce plastic containers.

In embodiments, the master batch comprises a carrier made of a polymer, such as a polyolefin or a styrene-based carrier, which improves the mass transfer between the foaming agent and the polymer to be foamed. However, other polymers, such as PVC for example, can also be used. This brings about a uniform and rapid foaming of the plastic.

In an embodiment, the master batch comprises a styrene-based carrier, such as polystyrene, but also styrene acrylonitrile, acrylonitrile-butadiene-styrene copolymers, and high impact polystyrene, and/or at least one alkyl sulfonate or an ethoxylated amine. In this implementation, a styrene-based carrier is suitable for mixing alkyl sulfonates with the polymer to be foamed, particularly when the polymer is a styrene.

In another embodiment, the master batch comprises a polyolefin-based carrier, such as polyethylene-based and/or polypropylene-based, and/or comprises a fatty acid ester or an ethoxylated amine, a glycerol stearate, and a glycerol monostearate.

A polyolefin-based carrier is suitable for mixing fatty acid esters with the polyolefin to be foamed and to foam it with high quality, particularly when the polymer to be foamed comprises a polyolefin, for example polyethylene or polypropylene.

In embodiments, the foaming agent with a polyolefin carrier comprises a fatty acid ester with a proportion of 0.2 percent to 0.8 percent, preferably 0.3 percent to 0.6 percent, especially preferably 0.4 percent to 0.5 percent of the fatty acid ester. In general, the storage life of the foaming agent and master batch can be varied with the proportion of the antistatic agent used. With an input of 0.45 percent glycerol monostearate, a storage life of one year is achieved. When 0.45 percent glycerol monostearate is used, the surface resistance of the master batch is 10¹⁰ to 10¹¹ Ω, thus exhibiting a very good antistatic effect, which prevents adhesion of the master batch to the device wall and results in dimensionally stable plastic products.

In addition, the embodiments relate a method for producing foamed plastic items, wherein a thermoplastic material is mixed in an extruder with a master batch as just described, and the mixture is molded in a shaping mold.

The embodiments likewise comprise foamed plastic items produced using the above-mentioned method. The foamed plastic items can be used in the packaging industry, the automotive industry, and the electrical equipment industry.

Within the scope of this invention, an extruder is understood to mean a continuously operating conveying machine that can convey, melt, compress, and homogenize plastic masses to be molded in the presence of pressure and heat. Examples of usable extruders are ≧20-D extruders or ≧24-D extruders.

The chemical foaming agent can be either premixed with the polymer, or is added in a separate, commercial metering mechanism such as is used for the addition of additives, e.g. color master batches, to the commercial blow-molding machine.

In embodiments, the master batch and the foaming agent can be fed simultaneously with the plastic, but it is also possible to provide the polymer and/or the master batch and to add the foaming agent to it by metered addition.

The extruder outlet orifice and the shaping mold can be connected by a connecting element. The foaming process can already be concluded before entry into the shaping mold. The inside walls of the shaping mold can be shaped in accordance with product requirements. As a result of the conditions prevailing inside the mold during the shaping process, the foamed mass that is introduced by the pressure is brought into the appropriate shape at the interior walls of the mold by a very low blowing pressure in the range from 0.5 to max. 2 bar. After molding, the shaping mold can be opened and the foamed plastic item can be removed as a finished product.

The quality of the forming can be optimized if a vacuum or underpressure is applied in the mold, such as an underpressure of −0.6 bar to −0.8 bar, and compressed air, constant compressed air, is conducted in the interior of the mold.

The application of a vacuum has the result that air inclusions (for instance, on the bottom or shoulder of a bottle), which can result in defects such as depressions in the end product, are removed, thus avoiding defects. In contrast, the supply of constant compressed air, with the aid of a blow mandrel which is placed such that it inflates the parison introduced into the shaping mold from the inside, improves the shaping process by pressing the foamed plastic mass against the inside wall of the mold better and faster. The pressure, which can be set to 0.5 bar to 2 bar, especially preferably to 0.5 bar to 1.5 bar, can be kept constant through the use of proportional valve technology, for example. Constancy of the pressure, in turn, aids the quality of the shaping.

Possibilities for use as thermoplastic materials in the method claimed according to the invention include low density polyethylene (LDPE), high density polyethylene (HDPE), linear low density polyethylene (LLDPE), polyisobutylene (PIB), polybutadiene, polyethylene terephthalate (PET), polyethylene copolymers, polypropylene (PP), polyamide (PA), low density polyamide (LDPA), polystyrene (PS), styrene copolymers, acrylonitrile butadiene styrene copolymers (ABS), styrene acrylonitrile copolymers, but also hard or soft polyvinyl chloride (PVC), and polycarbodiimides. The thermoplastic materials used within the scope of the invention belong to the group of polyolefins, styrenes, polyester, and polyamides, or is PVC.

In embodiments, the foaming of only the outer layer of a blow-molded article in accordance with the present invention takes place through coextrusion.

An example of an embodiment is given below:

A foaming agent containing 12.5 percent sodium hydrogen carbonate, 37 percent monosodium citrate, and 50 percent chalk with a particle size from 50 nm to 2000 nm, and 0.5 percent of 90 percent glycerol monostearate as an antistatic agent is fed into a 24-D extruder simultaneously with polypropylene so that the final concentration of the foaming agent is 0.7 percent by weight. Intake of the polypropylene mass and foaming agent is completed after a few turns of the screw, and the polypropylene mass enters the melting and mixing zone, where it is homogenized. It exits the extruder through an outlet nozzle of a blow head, and is introduced into the shaping mold. As the plastic melt exits the blow mandrel, the incorporated foaming gas expands and forms a uniform, bubble-filled parison. From entry into the extruder to exit from the nozzle, the polypropylene passes through the following temperature steps here: the propylene at the ambient atmospheric temperature is placed in the feed hopper of, for example, the blow-molding machine. The first heatable extruder zone is at 170 degrees Celsius and heating, mixing, and extrusion take place sequentially in the extruder at 210 degrees Celsius, 220 degrees Celsius, and 230 degrees Celsius. In this process the decomposition temperature of the foaming agent must be exceeded at one point in the extruder, which requires a temperature of 220 degrees Celsius to 230 degrees Celsius in the case of a carbonate- and citrate-based foaming agent. The foaming agent acts at a temperature of 180 degrees Celsius to 250 degrees Celsius. At the outlet nozzle, the temperature of the polypropylene is 210 degrees Celsius in the shaping step. Once the tubular polypropylene mass is fully enclosed by the shaping mold, the parison is pinched off and further shaped in the mold. The shaping mold is shaped for producing bottles, for example, and the polypropylene of the parison is pressed against the outer walls of the mold.

After conclusion of the shaping and cooling of the plastic item, the material remaining from the pinch-off process can easily be stamped off, and the mold can be opened and the product removed. The mold is then ready for the next shot. The use of the antistatic foaming agent results in an improvement in the cellular structure, which is noticeable in a soft, rough surface of the polypropylene product with an outstanding feel.

The flash, defective pieces, etc. that are produced can be ground and added to the virgin material without degrading the product quality.

While these embodiments have been described with emphasis on the embodiments, it should be understood that within the scope of the appended claims, the embodiments might be practiced other than as specifically described herein.

What is claimed is:

1. A foaming agent for producing foamed plastic items using a blow-molding process, comprising an antistatic agent.

2. The foaming agent for producing foamed plastic items of claim 1, wherein the antistatic agent comprises at least one of the following:
a. a fatty acid ester;
b. a glycerol monostearate;
c. a glycerol stearate;
d. an ethoxylated amine, wherein the ethoxylated amine has the following formula: 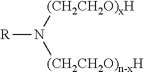
wherein, R represents an alkyl radical with 10 carbon atoms to 18 carbon atoms and n represents the total number of moles of ethylene oxide, where n corresponds to 2 moles to 15 moles; or
e. an alkyl sulfonate.

3. The foaming agent for producing foamed plastic items of claim 1, wherein the foaming agent comprises at least one of the following:
a. a sodium hydrogen carbonate;
b. a carboxylic acid; or
c. a solid acting as a nucleation agent.

4. A master batch comprising a foaming agent for producing foamed plastic items and an antistatic agent.

5. The master batch of claim 4, wherein the master batch comprises at least one of the following:
a. a styrene-based carrier; or
b. a polyolefin-based carrier.

6. The master batch of claim 4, wherein the master batch comprises a fatty acid ester at 0.2 percent to 0.8 percent.

7. A method for producing foamed plastic items, wherein a thermoplastic material is mixed in an extruder with the master batch of claim 5, and the mixture is molded in a shaping mold.

8. A method for producing foamed plastic items, wherein a thermoplastic material is mixed in an extruder with the master batch of claim 6, and the mixture is molded in a shaping mold.

9. A plastic container formed by using the foaming agent for producing foamed plastic items of claim 1.

10. A plastic container formed by using the master batch for producing foamed plastic items of claim 4.

11. A plastic container formed by using the method of claim 7.

12. A plastic container formed by using the method of claim 8.
